(19) United States
(12) Patent Application Publication
(10) Pub. No.: US 2025/0221434 A1
(43) Pub. Date: Jul. 10, 2025

(54) METHODS OF PREPARATION OF FOOD COMPOSITIONS AND BEVERAGES BASED ON WHOLE ALMOND OR WALNUT FRUITS AND RELATED PRODUCTS

(71) Applicant: RE-NUT AG, St. Gallen (CH)

(72) Inventors: Roland LAUX, Roggwil (CH); Tilo HÜHN, Schönenberg (CH)

(73) Assignee: RE-NUT AG, St. Gallen (CH)

(21) Appl. No.: 18/405,274

(22) Filed: Jan. 5, 2024

(51) Int. Cl. A23L 25/00; A23L 2/60; A23L 5/10

(52) U.S. Cl. CPC A23L 25/30; A23L 2/60; A23L 5/10

(57) ABSTRACT

Described is a method of processing nut fruits selected from almond fruits and/or walnut fruits, comprising: a) off-ground harvesting of the nut fruits; b) subjecting a mass comprising kernels, inner shell and green outer hull of the nut fruits to grinding to an average particle size of 500 μm or less to provide a ground mass; and c) further processing the ground mass to edible nut fruit solids, edible nut fruit-based products and/or nut fruit beverages; wherein the nut fruits have not been subjected to drying before step b). The method provides an ecologically friendly and simple alternative for processing almond fruits and/or walnut fruits to food and beverage compositions that are not only suitable for human consumption but simultaneously comprise high amounts of the natural antioxidants and bioactive materials present in the fresh fruits. Simultaneously, the method reduces risks related to both consumer health and the orchard environment, does not require extensive use of herbicides and/or pesticides, and reduces dust generation and tree water stress. In addition, edible products and beverages obtained by the aforementioned method are described.

### FIELD OF INVENTION

This invention relates to methods and/or techniques for the preparation of food compositions and/or beverages, wherein components of the outer shell covers and hulls of almond fruits and/or walnut fruits are incorporated to improve the yields of the bioactive materials and simultaneously provide environmental and economic benefits in the processing of almonds and/or walnuts.

In certain embodiments, this invention relates to food compositions and/or beverages obtained by the aforementioned methods and/or techniques.

### BACKGROUND OF THE INVENTION

An almond (P. amygdalus L.) fruit is characterised by four distinct parts, the inner kernel or meat, the brown skin, a hard middle shell portion, an outer green shell cover or hull, and a thin leathery coat layer (typically green or brown in appearance).

The commercial importance of the almond fruit is mainly related to its kernel. For several decades, almonds have been typically harvested by mechanical tree shakers which knock the almonds, still in their hulls, to the ground. Such a procedure is generally referred to as “on-ground harvesting”. The in-hull almonds are then usually sun-dried on the ground for about 7 to 14 days and then gathered and delivered for the following processing steps of cleaning and grading.

However, on-ground harvesting is accompanied with a number of disadvantages. For example, the contact of the almond fruits with orchard floor is associated with food safety risks, e.g. due to contamination with pesticides and herbicides, and insect infestation. Furthermore, excessive dust generation upon on-ground harvesting can severely impact almond trees. Dust particles can obstruct stomata responsible for regulating transpiration and gas exchange, which may negatively impact the capability of the plant to photosynthesis and respire, resulting in reduced growth, potential harm to tree health and lower yields. Furthermore, on-ground harvesting often results in inhomogeneous product quality.

In view of the above, off-ground harvesting methods have received increased interest to mitigate these problems.

Processing almond kernels with a moisture content greater than 6% in a huller/sheller has a higher risk of developing aflatoxins created by Aspergillus spp., the fungal molds that produce aflatoxins. Moreover, if the moisture content in the shell and hull is too high (above approximately 82% on a wet basis) the separation between shell and hull becomes difficult if not impossible, which is especially challenging after rainy seasons.

Therefore, in order to avoid molding and/or microbiological spoilage, and to facilitate the separation of the dried hulls from the shell, conventional on-ground and off-ground harvesting methods both involve a drying operation, such as sun-drying in-orchard on soil or a soil cover, windrow drying, pothole drying, or stockpile aeration. Mechanical drying methods away from orchards with ambient air or hot air (see e.g., C. Chen et al, LWT 2021, 152-112282) have likewise been developed.

Typical target moisture contents for almonds before stockpiling are less than 6% for in-shell kernels, less than 9% for total fruits and less than 12% for hulls. Commercial feed laws and regulations (California Department of Food and Agriculture (CDFA) validation 2773.5) define “almond hulls” as being “obtained by drying that portion of the almond fruit which surrounds the nut. They shall not contain more than 13.0 percent moisture, nor more than 15.0 percent crude fiber, and not more than 9 percent ash. If they contain more than 15.0 percent but less than 29.0 percent crude fiber, they shall be labeled ‘Almond Hull and Shell” (CDFA, 2009) (see also E. J. DePeters et al. Applied Animal Science 2020, 36 (6), 771-776). Almond hulls with more than 13% moisture content are classified as “Damaged Hulls” in CDFA feed regulations.

The removed dried almond hulls (almond mesocarp) were originally considered as a by-product and used for landfill or burned. However, in the last decades, their nutritive value has been recognized. Namely, almond hulls have been identified as rich source of natural antioxidants and other bioactive compounds, such as triterpenoids, flavanol glycosides, phenolic acids, catechin, protocatechuic acid, vanillic acid, and other polyphenolic compounds (see, e.g. A. J. Esfahlan et al., Food Chem. 2010, 120, 349-360). Nevertheless, almond hulls are still mainly used as feed for animals, especially ruminants (see E. J. DePeters et al. Applied Animal Science 2020, 36, 761-770) and broilers.

U.S. Pat. No. 6,716,465 B2 also discloses a process of preparing syrups, juices, confections, jams and jellies for human consumption based on aqueous extracts from dried almond hulls.

However, processing dried almond hulls for human consumption requires elaborate method steps to reduce the adstringency and bitterness, especially due to the contents of tannins, and to remove yeasts, fungi and bacteria, the content of which increases during the maturation and drying stages. Moreover, dried almond hulls, especially when being dried in contact with soil, are susceptible to infestation by pests and insects.

Similar considerations apply to walnuts (Junglans regia). Walnut fruits are typically harvested when the green outer hulls are starting to dry and split. Harvesting is done either manually or mechanically by shaking the tree causing the nut pods to fall to the ground. Since the nuts can become susceptible to infestation or rot of they remain on the ground for a prolonged time (especially since they are typically harvested in the rainy autumn season), the walnuts are usually collected, de-hulled and mechanically dried away from the orchards (e.g. by hot air or ambient air drying). The separated green hulls are usually discarded or composted.

However, making use of the nutritional ingredients (e.g., antioxidants) from walnut hulls could contribute to a reduction in the environmental impact and provide added value to the range of walnut-based food products.

Hence, it remains desirable to provide an ecologically friendly and simple method of processing almond fruits and/or walnut fruits to food and beverage compositions that are not only suitable for human consumption but simultaneously comprise high amounts of the natural antioxidants and bioactive materials present in the fresh fruits. Simultaneously, it would be desirable to provide a method of processing almond and/or walnut fruits, which reduces risks related to both consumer health and the orchard environment, does not require extensive use of herbicides and/or pesticides, and reduces dust generation and tree water stress.

Recently, methods of preparing food compositions and beverages based on culinary nuts by incorporating the hard shell material have been developed (see WO 2021/219589 A1 and WO 2023/152323 A1). However, the processing of outer hulls is not addressed.

### SUMMARY OF THE INVENTION

The present invention solves this object with the subject matter of the claims as defined herein. The advantages of the present invention will be further explained in detail in the section below and further advantages will become apparent to the skilled artisan upon consideration of the invention disclosure.

Generally speaking, in one aspect the present invention provides a method of processing nut fruits selected from almond fruits and/or walnut fruits, comprising: a) off-ground harvesting of the nut fruits; b) subjecting a mass comprising kernels, inner shell and green outer hull of the nut fruits to grinding to an average particle size of 500 μm or less to provide a ground mass; and c) further processing the ground mass to edible nut fruit solids, edible nut fruit-based products and/or nut fruit beverages; wherein the nut fruits have not been subjected to drying before step b).

In a further aspect, the present invention relates to nut fruit solids obtainable by the method according to the aspect described above.

In another aspect, the present invention relates to edible nut fruit-based products comprising the aforementioned nut fruit solids.

In yet another aspect, the present invention relates to a nut fruit beverage prepared by the aforementioned method.

In a further aspect, the present invention relates to a nut fruit oil extract obtained by the method described above, wherein step b) comprises b1) adding water to the nut fruits to form a suspension as the mass to be ground, and b2) wet grinding said suspension in one or more steps to an average particle size of less than 500 μm; and separating the suspension into a solid phase comprising nut fruit solids, a water phase (heavy phase) comprising nut fruit milk, and a fat phase (light phase) comprising nut fruit oil in step c).

### BRIEF DESCRIPTION OF THE DRAWINGS

FIG. 1 is a flow chart illustrating an exemplary method of processing nut fruits to nut fruit paste.

FIG. 2 illustrates an exemplary method of processing nut fruits to solid and liquid nut fruit-based product via phase separation.

### DETAILED DESCRIPTION OF THE INVENTION

For a more complete understanding of the present invention, reference is now made to the following description of the illustrative embodiments thereof:

### Method of Processing Nut Fruits

In a first embodiment, the present invention generally relates to a method of processing nut fruits selected from almond fruits and/or walnut fruits, comprising; a) off-ground harvesting of the nut fruits; b) subjecting a mass comprising kernels, inner shell and green outer hull of the nut fruits to grinding to an average particle size of 500 μm or less to provide a ground mass; and c) further processing the ground mass to edible nut fruit solids, edible nut fruit-based products and/or nut fruit beverages; wherein the nut fruits have not been subjected to drying before step b).

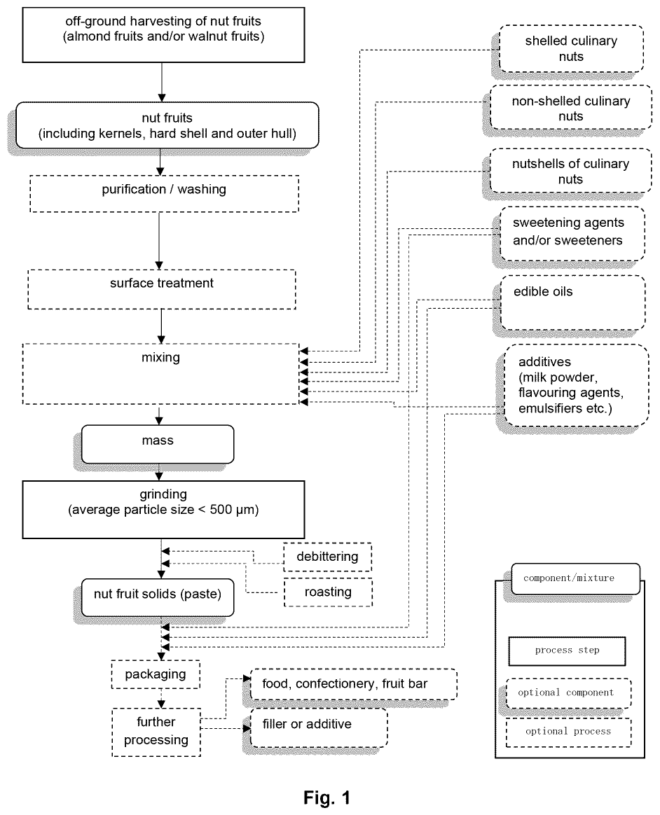

A non-limiting example of the method is illustrated in FIG. 1.

The expression “nut fruits”, “almond fruits” and “walnut fruits”, as used herein, denote whole nut fruits comprising the kernel (seed), the hard inner shell (endocarp) and the green outer hull of the respective nut fruit selected from almond fruits or walnut fruits. The term “green outer hull”, as used herein, is understood to at least comprise mesocarp and may consist of mesocarp and epicarp (i.e. the outer skin of the hull).

Nut fruits may be selected from almond fruits, walnut fruits or mixtures thereof.

The term “off-ground harvesting” denotes a method of collecting almond and/or walnut fruits off the trees instead of the ground. Off-ground harvesting according to step a) may be carried out manually (e.g. by catch frame methods) or mechanically (e.g. with harvesters), optionally in combination with step of manual or mechanical shaking. Compared to on-ground harvesting, off-ground harvesting methods reduce potential harm to tree and orchard health, improve harvesting yield and homogeneity of the product quality.

In the method of the present invention, the nut fruits have not been subjected to drying before step b). In this context, the term “drying” denotes an active drying operation which involves steps of distributing the harvested nut fruits on a surface and sun-drying and/or air-blow drying the nut fruits, e.g. in a pothole bin drying step, a stockpile aeration step, a concrete ground drying step or a windrow drying step. It will be understood that such active drying operations are not meant to not encompass minor drying effects (e.g., a moisture content reduction in the hulls of less than 10% on a wet basis) during the transport of the off-ground harvested nut fruits from the orchards to the processing stage.

In general, the moisture content in the green outer hull at the time of harvesting may substantially vary depending on the cultivar, watering measures and weather and climate conditions. However, the green outer hull subjected to step b) typically has a moisture content of more than 20% on a wet basis. In preferred embodiments, the green outer hull has a moisture content of more than 30% on a wet basis, more preferably more than 40%, further preferably more than 50%, especially preferably from 60% to about 83%. The moisture content may be determined according to methods known to the skilled artisan, e.g. by a drying oven method. Notably, when the moisture content is within the above-identified ranges, the green outer hull may be difficult to separate from the hard shell. However, since such a separation is not necessary in the method of the present invention, extensive drying for the purpose of facilitating the separation between the hull and the shell is not required either. It is further noted that hulls having a moisture content in the above-identified range may be classified as “damaged hulls” under some regulations. Surprisingly, it has been found that when the moisture content in the green outer hull is in the abovementioned ranges and almond and/or walnut fruits are harvested off-ground, a pathway to nut fruit-based food compositions and beverages with a fresh taste and a high content of nutritionally valuable ingredients (e.g., antioxidants, proteins, fats and sugars) may be provided, without the disadvantages usually associated with high moisture content, such as susceptibility to molding or microbiological spoilage and the resulting taste attributes. Moreover, the processing method is substantially simplified in comparison to conventional almond or walnut processing. Last but not least, cost savings due to abdication of drying steps may compensate for the expenditures associated with off-ground harvesting in comparison to on-ground procedures.

Nevertheless, hull material may be optionally separated from the nut fruits, independently treated (e.g. by grinding, heat-treatment, maceration and/or fermentation according to methods further explained below) and re-introduced into the process before step b) or during step c). In addition, dried hull material (e.g. from conventional on-ground processing) may be treated accordingly and introduced into the process before or after the grinding stage.

Optionally, a step of treating the surface of the almond fruits and/or walnut fruits nuts to remove surface contaminants may be carried out prior to step b). Surface contaminants may include dust-borne contaminants, pollutants, bacterial contaminants and/or mycotoxins, for example. For this purpose, the surface of the outer hull may be subjected to chemical sterilization (for instance, with microbiocidal substances such as alcohols (e.g. ethanol), aldehydes, oxidizing agents, phenolics or quaternary ammonium compounds), washing in sterile water, enzymatic treatment, surface sterilization or pasteurization by means of heat and/or irradiation with ionizing rays, ultrasound-based sterilization and combinations thereof, for example.

Alternatively, or in addition, a surface treatment may preferably include a step of stripping off the outermost layer (i.e. epicarp) of the hull surface. While not being limited thereto, said step may be performed by abrasive blasting, more preferably by abrasive blasting with bio-based abrasive media, such as fruit stone powders (e.g., powdered stones of olives, peaches, mangoes, plums, cherries, apricots or avocados) or nutshell-based abrasives.

Accordingly, the potentially contaminated surface of the outer hulls may be selectively removed while leaving the valuable constituents intact.

Prior to grinding in step b), the nut fruits may be soaked in water or steam-treated to dissolve sugars and sugar alcohols present in the hulls, which enter into solution. In further preferred embodiments, the nut fruits are soaked in water or steam-treated at a temperature of about 45 to 135° C., more preferably between 45° C. and 100° C. Thereafter, the nut fruits are separated from the soaking or steaming water (e.g., by sieving or filtration). The soaking water or steam comprising sugars and sugar alcohol may be subjected to a concentration step to provide a sweetener composition, which may be reintroduced at a later stage of the processing method (e.g. in step c)).

If desired, the green outer hulls may be separated from the non-shelled nuts, independently treated (e.g. by separate grinding methods, maceration, debittering steps as outlined below) and reintroduced into the mass subjected to step b).

In step b), the mass comprising kernels, inner shell and green outer hull of the nut fruits is ground to an average particle size of 500 μm or less to provide the edible food composition.

Average particle sizes of 200 μm or less, 100 μm or less, 50 μm or less, 30 μm or less or 20 μm or less are especially preferred in view of the texture and mouthfeel of the resulting product. The grinding of the mass may be carried out in one or in multiple steps. In general, the average particle size may be measured as volume moment mean (D [4,3]), and is typically defined by all particle sizes contributing according to their volume fraction in the collective, so that the average particle size in the interval is weighted with the corresponding volume portion and all these weighted values are averaged arithmetically. The particle sizes and their distribution may be suitably determined by methods known in the art (e.g. by a particle size analyzer).

Culinary nut kernels (seeds), dehulled culinary nuts (seeds+endocarp) and/or culinary nut shells (endocarp) may be admixed to the mass before step b) to add different flavors, to modify the texture of the food composition or to facilitate the grinding process. For this purpose, the term “culinary nut”, as used herein, includes any tree nut, seed or legume, including any species of any genus of nuts, legumes, or seeds, and any mixtures thereof, while nuts, drupe seeds, nut-like gymnosperm seeds and nut-like angiosperm seeds are preferred. A single varietal or species may be used, or any conceivable mixtures of nuts, or mixtures of nuts and legumes, or combinations of tree nuts, seeds and legumes. As examples of nuts, almonds, pecans, walnuts, cashews, pistachios, peanuts, kola nuts, palm nuts, hazelnuts, filberts, Brazil nuts, macadamia nuts, chestnuts, and mixtures thereof may be mentioned, while suitable seeds may include oat, sesame seeds, pine nuts, sunflower seeds, pumpkin seeds, beans and/or rice for example. It is also within the scope of the present disclosure to use legumes (including, but not limited to soybeans, peanuts, navy beans, kidney beans, lima beans, string beans, pinto beans, chickpeas (garbanzo beans), lentils, peas, black-eyed peas, for example) particularly those falling into the definition of culinary nuts in ordinary parlance, such as peanuts, for example. In particularly preferred embodiments, the term “culinary nut” comprises hazelnuts, almonds, walnuts, cashews, pistachios, pecans, macadamia nuts, peanuts, and combinations thereof.

In a preferred embodiment, almond kernels or de-hulled almonds may be added to the mass before step b) in order to modify the taste and texture of the desired food composition. “De-hulled almonds” denote in-shell almonds consisting of almond kernels and the hard shell (endocarp).

Alternatively or in addition, walnut kernels or de-hulled walnuts may be added to the mass before step b) in order to modify the taste and texture of the desired food composition. “De-hulled walnuts” denote in-shell walnuts consisting of walnut kernels and the hard shell (endocarp).

In a preferred embodiment, the mass subjected to step b) comprises green outer hull of the nut fruits at a content of at least 0.05 wt.-% based on the total weight of the mass, more preferably at least 0.1 wt.-%, further preferably at least 1 wt.-%, especially preferably at least 2 wt.-% on a dry basis based on the total weight of the mass, even further preferably at least 3 wt.-%. Most preferred green outer hull contents range from 5 to 63 wt.-%, such as from 10 to 60 wt.-%.

In a particularly preferred embodiment, the mass subjected to step b) consists of whole, off-ground harvested almond fruits and/or walnut fruits.

In a preferred embodiment of the present invention almond fruits are used as nut fruits.

Optionally, further additives may be added to the mass depending on the recipe and the desired textural and organoleptic properties. While not being limited thereto, exemplary additives may include sugars or other sweeteners (including maple syrup, honey, molasses, sucrose, fructose, glucose syrup, invert sugar, fruit sugar, corn syrup, sucralose, acesulfame potassium, aspartame, saccharin, cyclamates, acesulfame-K, thaumatin, chalcone, cyclamate, stevioside, stevia, sorbitol, xylitol and lactitol etc.), salt or salt substitutes, flavoring agents (e.g. cocoa powder, cocoa liquor, cocoa beans, coffee beans, vanillin or the like), milk powder, edible oils (essential oils or vegetable oils, such as palm oil, canola oil, peanut oil, walnut oil, rapeseed oil, cottonseed oil, soybean oil or coconut oil, for example), vitamins, minerals, proteins (e.g., whey protein, soy protein, albumin, sunflower seeds etc.), fruit pieces, herbs and/or spices (including without limitation cinnamon, ginger, coriander, cumin, turmeric, chili, pepper, cardamom, cloves, nutmeg, etc.), preservatives, colorants, thickeners, stabilizers (e.g. saturated triglycerides, monoglycerides, diglycerides and combinations thereof), emulsifiers (e.g., lecithin) and combinations thereof, for example.

In some embodiments, it may be preferable to subject the ground mass obtained in step b) to roasting in step c), whereupon development of complex flavors during Maillard reactions occurring during roasting is further promoted. In a preferred embodiment, salt (e.g., sodium chloride) may be added before the roasting step in order to enhance the solubility of proteinogenic substances as precursors for the Maillard reactions. Notably, especially green hulls of almonds exhibit relatively high contents of sugars and sugar alcohols, which by themselves contribute to a sweet taste of the resulting food composition or beverage. Advantageously, it has been found that roasting the ground mass including endocarp further results in an enhanced perception of sweet constituents in the final edible product, so that less sugar and/or sweetener is required in comparison to conventional products.

In a preferred embodiment, the roasting step is carried out at a temperature of more than 65° C. and 200° C. or less, more preferably between 8° and 160° C.

The method of carrying out the roasting is not particularly limited and may be accomplished in a drum dryer, for example. In a preferred embodiment, the roasting step is carried out in a mixing device comprising a cylindrical, tubular body arranged with its axis horizontal and closed at its opposite ends by end plates, and having a coaxial heating or cooling jacket through which, for example, diathermic oil or another fluid is intended to flow to keep the internal wall of the body at a predetermined temperature. The tubular body has an inlet and outlet openings for the solid phase. The outlet opening communicates, by means of a duct, with a device for separating an aroma phase (i.e. a nut fruit aroma) from the dried product. The device further comprises a bladed rotor is supported for rotation in the tubular body, its blades being arranged as a helix and oriented for centrifuging the solid phase being processed and simultaneously transporting it towards the outlet opening. The roasting step may be followed by a cooling step, which may be carried out by air cooling, for example.

In addition or in alternative, the finely ground paste obtained in step b) may be subjected to a pH modulation step in step c), preferably before the optional roasting step, in order to modify the physical properties, taste profile and subsequent development of flavors. For this purpose, bases (alkalisation) or acids (e.g., treatment with acetic acid or citric acid) may be employed.

The above-described method enables simple, rapid and inexpensive preparation of a nut fruit based food and make ideal use of the naturally present, nutritionally beneficial components. In preferred embodiments, steps b) and c) may be carried out continuously in a time frame of less than 100 minutes, more preferably less than 60 minutes, further preferably less than 20 minutes.

In general, step b) may be performed as a dry-grinding or a wet-grinding method.

In a preferred embodiment, step b) is performed as a dry-grinding step without addition of a liquid (such as water, for example), particular for the preparation of a nut fruit paste (see FIG. 1, for example).

In this method, the nut fruit paste may be subjected to a roasting step, preferably at a temperature of more than 65° C. and 200° C. or less, further preferably between 8° and 160° C.

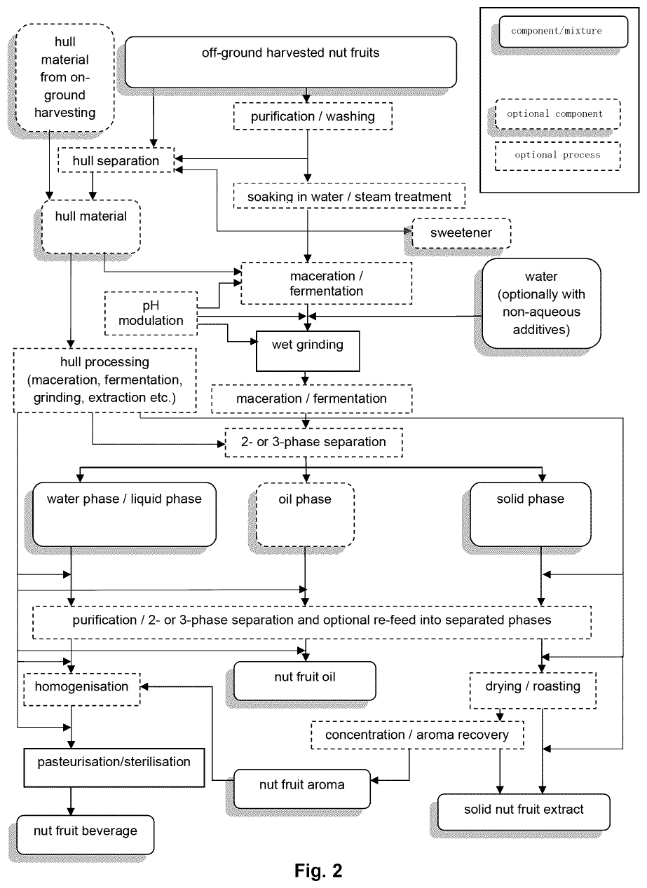

However, since it enables the provision of a wider choice of products and simultaneously facilitates the removal of undesired constituents, a wet-grinding method may be preferable. In this respect, it is particularly preferred that step b) comprises the steps of: b1) adding water to the nut fruits to form a suspension as the mass to be ground, and b2) wet grinding said suspension in one or more steps to an average particle size of less than 500 μm; and that step c) comprises a step of separating the suspension into at least a solid phase comprising nut fruit solids and a liquid phase. An exemplary method according to this embodiment is illustrated in FIG. 2.

In step b1), water is added to form a suspension. While not being particularly limited, the weight ratio of water to the nut fruits in the formed suspension is preferably between 1:1 to 15:1, more preferably 2:1 to 12:1, especially preferably between 2.5:1 to 10:1, which may advantageously affect the processability in the further steps (e.g. facilitated pumping, grinding and/or easier phase separation).

While it may be preferred to use water (e.g. tap water) in step b1), alternative water-containing liquids may also be used as a source of water in order to introduce additional flavors, which may favorably interact with the primary and secondary flavors of the nut fruits at subsequent stages of the processing methods. Such liquids may include liquids having water contents of from 60 to about 95% by weight, such as fruit juices, fruit juice concentrates, or milk, for example. In case such water-containing liquids are used, it is generally preferable that the water content in the formed suspension falls into the above-defined ratios. In general, it is preferred that the added water or water-containing liquid has a temperature of 40° C. or less, more preferably 30° C. or less, and particularly preferably 25° C. or less. However, for specific purposes, higher temperatures may be employed as desired. For instance, in order to effect enzyme deactivation, water or water-containing liquids having temperatures of up to 95° C., typically up to 90° C. may be desirably used.

When improved extraction yields of lipophilic substances are targeted and/or the introduction of flavors is desired, further extraction agents may be added in addition to water. Such extraction agents may include one or more organic solvents, which may be preferably selected from the group of C₁-C₈ alcohols, C₂-C₈ ketones, C₃-C₇ esters, C₂-C₈ ethers, C₄-C₁₀ lactates, halogenated C₁-C₆ hydrocarbons and C₁-C₈ alkanes, more preferably from C₁-C₈ alcohols, C₁-C₈ alkanes, C₂-C₈ ethers, further preferably from the group of methanol, ethanol, isopropanol, acetone, methyl acetates, ethyl acetates, diethylether, methyl t-butyl ether and hexane, and especially preferably from ethanol, hexane and methyl t-butyl ether. In a particularly preferred embodiment, the organic solvent is ethanol. While not being limited thereto, further examples of additional extraction agents may comprise animal oil (e.g. fish oil), liquid dairy product, vegetable oil (e.g., olive, soybean, rapeseed, canola, sunflower, safflower, peanut, cottonseed, coconut, palm, avocado and rice bran oil) and combinations thereof, which may be infused with further flavors (e.g. cocoa, vanilla, curcuma, chili, cardamom, pepper or the like). When mixed with the water or water-containing liquid, it is preferred that said additional extraction agent is comprised at less than 90% by volume relative to the volume of water or water-containing liquid, preferably less than 70% by volume. The temperature of the extraction agent is not particularly limited and may be suitably adjusted by the skilled artisan.

In embodiments, it may be preferable to modify the pH value of the water or water-containing liquid, for example by addition of one or more acids (e.g. acetic acid, citric acid, or the like) or buffers, preferably during or after step (b1). Typically, said pH modulation may involve addition of buffer solution, base or acid in order to fine-tune the subsequent extraction profile.

In addition, carbohydrates may be added to the water or water-containing liquid, which may promote the efficient separation of the oil phase in the subsequent steps. While not being limited thereto, examples of suitable carbohydrates are mentioned in US 2018/0079991 A1.

Forming the aqueous suspension in step b1), i.e. before step b2) has the advantage that solid material is softened prior to grinding and the cooling effect of water further minimises the mechanical burden on milling equipment. The methods and devices used for wet grinding in step b2) are not particularly limited as long as significant frictional heat production or high mechanical forces are avoided in order to preserve the heat-sensitive components of the nut fruits. For this purpose, step b2) preferably comprises: one or more coarse grinding step(s) to an average particle size of 500 μm or less, and a subsequent fine grinding step to an average particle size of less than 100 μm, preferably less than 90 μm, even more preferably 80 μm or less, such as from 0.5 to 50 μm or from 1 to 20 μm. Reducing the particles to the above size ranges range substantially increases the exposed surface area of the particle material for optimized wetting, which enables improved extraction results (such as improved extraction of fats or lipids, aromatic substances, and/or polyphenols). The particle size reduction may be accomplished by using hammer mills, disc mills (e.g. perforated disc mill), colloid mills (e.g. toothed colloid mills), ball mills or corundum stone mills, for example. In a particularly preferred embodiment, the one or more coarse grinding step(s) are performed with a perforated disc mill, and the fine grinding step is performed by use of a toothed colloid mill and/or a ball mill.

In preferred embodiments, the method of the present invention comprises a step of subjecting the suspension to a maceration and/or fermentation step, preferably before or directly after step b), further preferably during or after wet-grinding in step b2). Advantageously, such processes may be performed to reduce excessive contents of undesirable components, such as phytic acid, for example. Maceration enables the aqueous extraction agent to additionally wet the solid material through enlargement of the surface area. In a preferred embodiment, maceration may be performed enzymatically. In addition, it has been found that maceration plays an important role in improving the yield of nutritionally beneficial components (especially aroma compounds). For this purpose, the nut fruits may be left to macerate in an aqueous medium, either in a non-ground state before step b) or in a ground state after step b). If desired, the aqueous maceration medium may be pH-modulated by addition of acid, base or buffers to a desired pH. The duration of the maceration process is not particularly limited, but a duration of from 1 to 20 hours is preferred, and a duration of 2 to 12 hours is especially preferred. The processing of macerated nut fruits generally results in improved aromatic yield. In further preferred embodiments, maceration in an aqueous medium is combined with a subsequent extraction in step b2), wherein one or more organic solvent(s) according to the above description is (are) added to the aqueous extraction medium.

Fermentation may be performed by using microbial starter cultures, including indigenous and non-indigenous bacterial and yeast species known in the art, optionally in combination with enzymatic treatment, while the end point of fermentation may be monitored by chemical measurement of pH, which enables favorable control over the fermentation process when compared to natural, spontaneous fermentation. In addition or alternatively, the fermentation process may be controlled by monitoring temperature, pressure, gas development (e.g. CO₂) and/or the density.

It will be understood that the wording “fermentation”, as used herein, may encompass spontaneous or controlled (non-spontaneous) fermentation processes. For example, an incubation step in an incubation medium may be implemented to simulate microbial (i.e. yeast and bacterial) fermentation. Although not being particularly limited as long as the concentration of incubation medium is sufficiently high to prevent spontaneous fermentation by endogenous microbes, the concentration of ethanol in the incubation medium may be from 1 to 20 vol.-%, preferably between 1 and 12 vol.-%. In an especially preferred embodiment from the viewpoint of germination inhibition efficiency and processing costs, the concentration of ethanol in the incubation medium is at least 2 vol.-% and less than 7 vol.-%. The incubation medium may further comprise enzymes known in the art for controlled enzyme-catalyzed reactions in order to facilitate formation of aroma precursors, such as hydrophilic oligopeptides and hydrophobic free amino acids, for example. If applied, the incubation may be carried out in a single step or in multiple incubation steps, wherein different incubation conditions and/or incubation media are employed. As will be known to the skilled artisan, the incubation conditions, such as pH or temperature, may be varied within one single incubation step. The incubation step may further encompass one or more mechanical and/or physical treatment steps commonly known in the art before or during the incubation. Although not being limited thereto, such a mechanical treatment may comprise stirring, mixing and agitating, and combinations thereof, while said physical treatment may comprise an infrared treatment and/or a vacuum treatment, for example.

In step c), the solid phase is separated from the liquid phase. Preferably, devices employing centrifugal forces may be utilized to achieve mechanical particle separations, such as decanters or nozzle separators, while decanters are particularly preferred.

In a preferred embodiment of the wet-grinding method, step c) comprises separating the suspension into three phases, i.e. a solid phase comprising nut fruit solids, a water phase (heavy phase) comprising a nut fruit beverage, and a fat phase (light phase) comprising nut fruit oil.

Such a process is desirable if gentle extraction of nut fruit oils (without the necessity of carbohydrate addition or pressing steps) is desired and/or if it is desired to minimise the fat content in the nut fruit beverage without compromising the flavor richness (as would be the case by dilution, for example). Although a three-phase separation may be achieved by subsequent steps, for instance, by de-oiling the liquid phase obtained in step b2), it is preferred to conduct three-phase separation in a single step, e.g. in a three-phase decanter.

Multiple phase separation and recombination steps may be employed to achieve an improved separation between the liquid phase(s) and the solid phase. The thus obtained purified phases may be re-fed to the respective phases obtained after the first separation stage.

For example, the water and oil phases obtained in the three-phase separation may be further purified, e.g. by performing a second three-phase separation step, in order to further improve the recovery and yield of extracts. The solid phase may filtered or centrifuged to separate remaining water, which may be recombined with the water phase from the initial decanting step or at a later processing stage of said phases. Also, the water phase may be subjected to further purification steps, e.g. by filtration using vacuum rotation filters in order to remove fine particles.

In general, two varieties of almond fruits are used in the food sector: sweet almond (P. dulcis, variety dulcis) and bitter almond (P. dulcis, variety amara). Whereas sweet almonds represent the more widespread variety consumed as nuts and used in cooking or as a source of almond oil or almond meal, bitter almonds may likewise be employed, particularly for extraction of oils for flavouring extracts for foods and liqueurs. However, bitter almonds may contain undesirably high contents of amygdalin (D-mandelonitrile-2-D-gentiobioside), which is a cyanogenic glycoside, the enzymatic degradation of which can lead to the production of cyanide when kernels are macerated or crushed. Accordingly, the use of bitter almonds may require a step of reducing the cyanide content in the mass in step c), e.g., by baking, microwave treatment, water boiling methods or ultrasonic treatment, respectively, among which an ultrasonic treatment is particularly preferred. Step c) may further comprises a debittering step.

When almond fruits are selected as nut fruits, the debittering step may comprise a step of separating tannins and/or catechins present in the green outer hull of the nut fruits from the liquid phase (in case of a liquid-solid separation) or the water phase (in case of a three-phase separation), respectively, in which the tannins and/or catechins are mainly found upon fine grinding. Tannins and/or catechins are mainly responsible for bitterness or adstringency perceived in almond-based food and may be removed from the liquid or water phase by membrane separation, column adsorption or precipitation, to provide a tannin extract and/or catechin extract. In a further preferred embodiment, tannins and/or catechins are separated by precipitation, e.g., by adding a precipitating agent selected from a protein preparation, a salt and/or a polymeric compound to the liquid phase. Examples of protein preparations include, but are not limited to gelatin. Inorganic salts, such as aluminum chloride, zinc chloride (in the basic pH range) or ammonium sulfate may be effectively used as precipitating agents. Polymeric compounds, such as polyvinylpyrrolidone (PVP) or methylcellulose may be used for precipitating both tannins and catechins. Methylcellulose is particularly advantageous since it is food-grade and non-toxic. The thus obtained tannin and/or catechin extracts may be concentrated, e.g. by reverse osmosis/ultrafiltration. Optionally, the concentrated extracts may be subjected to drying (e.g., spray drying) to a powder, for example. The extracts may be reintroduced into the process to fine-tune the balance between the desired adstringency, bitterness and antioxidant activity of the food or beverage product.

In case of walnut fruits, high juglone concentrations in the green outer hull of the walnut fruits may contribute to undesirable bitterness and adstringency in the final products. Therefore, it may be preferred to reduce juglone contents in the ground mass or the solid phase (upon phase separation) by ultrasound-assisted maceration or by separation through solvent extraction to obtain a juglone extract the ground walnut fruits. Suitable extraction solvents include, but are not limited to methanol, ethanol, petroleum ether, chloroform or hexane, for example. In a further preferred embodiment, juglone is extracted by using supercritical fluids. Particularly advantageous extraction may be achieved with ethanol-assisted extraction with supercritical carbon dioxide.

The liquid phase (in case of a liquid-solid separation) or the water phase (in case of a three-phase separation) obtained by the above-described processes may be subjected to a pasteurisation or sterilisation to provide a nut fruit-based beverage.

### Nut Fruit Products

The food products and beverages produced by the methods of the present invention exhibit characteristic nutritional profiles and unique aromatic and organoleptic properties, based on the incorporation of nut fruit hulls.

In a second embodiment, the present invention relates to nut fruit solids obtainable by the method according to the first embodiment described above. The nut fruits solids directly obtained after the grinding (and optional phase separation) stage exhibit a sweet, fresh taste attributed to the hull material, favorably high contents of antioxidants and bioactive substances, as well as favorably smooth texture and mouthfeel due to the fine grinding step described in step b) and the therein described particle sizes. In general, the nut fruit solids or the solid phase obtained in step c) may be directly packaged (e.g. in a container), pressed into a nut fruit bar and/or used for consumption or confectionery processing, for example.

A particularly preferred embodiment is a nut fruit bar obtained by forming the nut fruit solids or the solid phase obtained in step c) into a bar shape. The resulting bar may be used as a healthy, natural and protein-rich alternative to conventional fruit or protein bars. In a particularly preferred embodiment, the nut fruit solids or the solid phase obtained in step c) are formed in the shape of an almond or walnut, respectively.

Nevertheless, it is understood that the nut fruit solids may be further processed to modify the flavor, sweetness, texture and/or viscosity of the product to the desired recipe, e.g. by mixing the same with additives described above with respect to step b). For instance, the nut fruit solids may be optionally homogenized and/or ultrafinely ground to further reduce the particle size (e.g. to an average particle size of 25 μm or less or 15 μm or less) to create a smoother texture.

Accordingly, a third embodiment of the present invention relates to edible nut fruit-based products comprising the nut fruit solids described in conjunction with the first and second embodiments. The nut fruit solids may be used in any food (both for human and animal consumption) to replace conventional filler materials. In fact, due to the high contents of biologically active components, the ground endocarp and mesocarp serves as a nutritionally beneficial alternative to commonly used, non-nutritive food fillers.

In a preferred embodiment, the nut fruit solids (e.g. nut fruit paste) is processed in a refiner or a refiner/conche (e.g. a Macintyre all-in-one refiner/conche) in analogy to chocolate processing, to remove volatiles, acidity and moisture, to effect mixing with optional additives such as sugar, milk powder etc., and to improve the texture of the final product. If desired, larger particles may be introduced into the paste at this stage, including, but not limited to fruit pieces, nut particles (which may be roasted, oil-fried and/or sugar coated), coffee nibs, cocoa nibs, chocolate pieces, caramel pieces, or the like. However, in order to make full use of the benefits of the present invention, it is preferred that the edible nut fruit-based products still contain at least 0.03 wt.-% of the hull material based on the total weight of solids, more preferably at least 0.05 wt.-%, and especially preferably at least 0.5 wt.-%, such as 1 wt.-% or more or 5 wt.-% or more.

A fourth embodiment of the present invention relates to a nut fruit beverage prepared by the method according to the first embodiment, specifically from the water or liquid phase obtained upon wet-grinding the mass comprising kernels, inner shell and green outer hull of the nut fruits to grinding and subsequent phase separation. For the preparation of the nut fruit beverage, the liquid phase (in case of a liquid-solid separation) or the water phase (in case of a three-phase separation) obtained by the first embodiment is subjected to a pasteurization or sterilization step. The nut fruit beverage of the present invention provides a valuable addition to plant-based beverages and incorporates the hydrophilic sugars and antioxidants present in the hulls of the almond and/or walnut fruits.

A fifth embodiment of the present invention relates to a nut fruit oil extract obtained by the method according to the first embodiment, wherein step b) comprises b1) adding water to the nut fruits to form a suspension as the mass to be ground, and b2) wet grinding said suspension in one or more steps to an average particle size of less than 500 μm; and separating the suspension into a solid phase comprising nut fruit solids, a water phase (heavy phase) comprising nut fruit milk, and a fat phase (light phase) comprising nut fruit oil in step c). Nut fruit oil extracts of the present invention advantageously incorporate the nutritionally valuable lipophilic constituents present in the hulls of the almond and/or walnut fruits.

In view of the above, the present invention provides a wide variety of food and beverage compositions based on almond fruits and/or walnut fruits to that are not only suitable for human consumption but simultaneously comprise high amounts of the natural antioxidants and bioactive materials present in the fresh fruits.

It will be appreciated that the present invention may employ any of the preferred features specified above with respect to the description of the first to third embodiments, and that the preferred features may be combined in any combination, except for combinations where at least some of the features are mutually exclusive.

Exemplary embodiments of the present invention include the following items 1 to 30:

1. A method of processing nut fruits selected from almond fruits and/or walnut fruits, comprising;
a) off-ground harvesting of the nut fruits;
b) subjecting a mass comprising kernels, inner shell and green outer hull of the nut fruits to grinding to an average particle size of 500 μm or less to provide a ground mass; and
c) further processing the ground mass to edible nut fruit solids, edible nut fruit-based products and/or nut fruit beverages;
wherein the nut fruits have not been subjected to drying before step b).

2. The method according to item 1, wherein the green outer hull has a moisture content of more than 20% on a wet basis, preferably more than 30%, further preferably more than 40%, and especially preferably more than 50%.

3. The method according to item 1 or item 2, wherein almond kernels or de-hulled almonds are added to the mass before step b).

4. The method according to any one of items 1 to 3, wherein walnut kernels or de-hulled walnuts are added to the mass before step b).

5. The method according to any one of items 1 to 4, wherein the mass subjected to step b) comprises green outer hull of the nut fruits at a content of at least 0.05 wt.-% on a dry basis based on the total weight of the mass, preferably at least 0.1 wt.-%, further preferably at least 1 wt.-%, even more preferably at least 2 wt.-%, especially preferably at least 3 wt.-%, and most preferably between 5 to 63 wt.-%.

6. The method according to any one of items 1 to 5, wherein the mass subjected to step b) consists of whole, off-ground harvested almond fruits and/or walnut fruits.

7. The method according to any one of items 1 to 6, wherein the nut fruits are almond fruits.

8. The method according to any one of items 1 to 7, wherein sweetening agents and/or sweeteners are added to the ground mass after step b) to provide a mixture, and the mixture is subsequently subjected to a roasting step, preferably at a temperature of more than 65° C. and 200° C. or less, further preferably between 8° and 160° C.

9. The method according to any one of items 1 to 8, wherein in step c), the ground mass is subjected to a roasting step before step c), preferably at a temperature of more than 65° C. and 200° C. or less, further preferably between 8° and 160° C.

10. The method according to any one of items 1 to 9, wherein steps b) and c) are carried out continuously in a time frame of less than 100 minutes, preferably less than 60 minutes, more preferably less than 20 minutes.

11. The method according to any one of items 1 to 10, further comprising a step of treating the surface of the almond fruits and/or walnut fruits nuts to remove surface contaminants.

12. The method according to any one of items 1 to 11, wherein step b) is performed as a dry-grinding step without addition of a liquid to provide a nut fruit paste.

13. The method according to item 12, wherein the nut fruit phase is subjected to a roasting step, preferably at a temperature of more than 65° C. and 200° C. or less, further preferably between 8° and 160° C.

14. Nut fruit solids obtained by the method according to any one of items 12 or 13.

15. The method according to any one of items 1 to 11,
wherein step b) comprises the steps of:
   b1) adding water to the nut fruits to form a suspension as the mass to be ground, and
   b2) wet grinding said suspension in one or more steps to an average particle size of less than 500 μm; and
wherein step c) comprises a step of separating the suspension into at least a solid phase comprising nut fruit solids and a liquid phase.

16. The method according to item 15, further comprising a step of subjecting the suspension to a maceration or fermentation step before step b2).

17. The method according to claim 15 or 16, wherein the solid phase is further subjected to a roasting step, preferably at a temperature of more than 65° C. and 200° C. or less, further preferably between 8° and 160° C.

18. The method according to any one of items 15 to 17, wherein step c) comprises a debittering step.

19. The method according to item 18, wherein the nut fruits are almond fruits, and wherein the debittering step further comprises a step of separating tannins and/or catechins present in the green outer hull of the nut fruits from the liquid phase, by membrane separation, column adsorption or precipitation, to provide a tannin extract and/or catechin extract.

20. The method according to item 19, wherein tannins and/or catechins are separated by precipitation, by adding a precipitating agent selected from a protein preparation, a salt and/or a polyelectrolyte to the liquid phase.

21. The method according to item 18, wherein the nut fruits are walnut fruits, and wherein the debittering step further comprises a step of separating juglone present in the green outer hull of the walnut fruits from the ground walnut fruits by solvent extraction to obtain a juglone extract.

22. The method according to item 21, wherein solvent extraction comprises extraction with supercritical fluids.

23. The method according to item 22, wherein solvent extraction comprises ethanol-assisted extraction with supercritical carbon dioxide.

24. The method according to any one of items 15 to 23, further comprising a step of pasteurizing or sterilizing the liquid phase to provide a nut fruit-based beverage.

25. The method according to any one of items 15 to 24, wherein step c) comprises separating the suspension into a solid phase comprising nut fruit solids, a water phase (heavy phase) comprising nut fruit milk, and a fat phase (light phase) comprising nut fruit oil.

26. The method according to item 24, further comprising a step of pasteurizing or sterilizing the water phase to provide a nut fruit-based beverage.

27. Nut fruit beverage prepared by the method according to any one of items 24 or 26.

28. Nut fruit solids obtained by a method according to any one of items 1 to 27.

29. Edible nut fruit-based products comprising the nut fruit solids according to item 28 or the nut fruit beverage according to item 27.

30. The edible nut fruit-based products according to claim 29, containing at least 0.03 wt.-% of the hull material based on the total weight of solids, preferably at least 0.05 wt.-%, and more preferably at least 0.5 wt.-%, further preferably 1 wt.-% or more and especially preferably 5 wt.-% or more.

31. Nut fruit oil extract obtained by a method according to item 25.

Once given the above disclosure, many other features, modifications, and improvements will become apparent to the skilled artisan.

1. A method of processing nut fruits selected from almond fruits and/or walnut fruits, comprising;
a) off-ground harvesting of the nut fruits;
b) subjecting a mass comprising kernels, inner shell and green outer hull of the nut fruits to grinding to an average particle size of 500 μm or less to provide a ground mass; and
c) further processing the ground mass to edible nut fruit solids, edible nut fruit-based products and/or nut fruit beverages;
wherein the nut fruits have not been subjected to drying before step b).

2. The method according to claim 1, wherein the green outer hull has a moisture content of more than 20% on a wet basis.

3. The method according to claim 1, wherein the green outer hull has a moisture content of more than 50% on a wet basis.

4. The method according to claim 1, wherein almond kernels or de-hulled almonds are added to the mass before step b).

5. The method according to claim 1, wherein walnut kernels or de-hulled walnuts are added to the mass before step b).

6. The method according to claim 1, wherein the mass subjected to step b) comprises green outer hull of the nut fruits at a content of at least 0.05 wt.-% on a dry basis based on the total weight of the mass.

7. The method according to claim 1, wherein the mass subjected to step b) comprises green outer hull of the nut fruits at a content of between 5 to 63 wt.-% on a dry basis based on the total weight of the mass.

8. The method according to claim 1, wherein the mass subjected to step b) consists of whole, off-ground harvested almond fruits and/or walnut fruits.

9. The method according to claim 1, wherein the nut fruits are almond fruits.

10. The method according to claim 1, wherein sweetening agents and/or sweeteners are added to the ground mass after step b) to provide a mixture, and the mixture is subsequently subjected to a roasting step.

11. The method according to claim 10, wherein the roasting step is carried out at a temperature of more than 65° C. and less than or equal to 200° C.

12. The method according to claim 1, wherein in step c), the ground mass is subjected to a roasting step before step c).

13. The method according to claim 12, wherein the roasting step is carried out at a temperature of more than 65° C. and less than or equal to 200° C.

14. The method according to claim 1, wherein steps b) and c) are carried out continuously in a time frame of less than 100 minutes.

15. The method according to claim 14, wherein steps b) and c) are carried out continuously in a time frame of less than 20 minutes.

16. The method according to claim 1, further comprising a step of treating the surface of the almond fruits and/or walnut fruits nuts to remove surface contaminants.

17. The method according to claim 1, wherein step b) is performed as a dry-grinding step without addition of a liquid to provide the nut fruit solids.

18. Nut fruit solids obtained by the method according to claim 17.

19. The method according to claim 17, wherein the nut fruit phase is subjected to a roasting step.

20. The method according to claim 17, wherein the roasting step is carried out at a temperature of more than 65° C. and less than or equal to 200° C.

21-44. (canceled)
